(19) United States
(12) Patent Application Publication
(10) Pub. No.: US 2019/0114482 A1
(43) Pub. Date: Apr. 18, 2019

(54) METHODS FOR PROVIDING TASK RELATED INFORMATION TO A USER, USER ASSISTANCE SYSTEMS, AND COMPUTER-READABLE MEDIA

(71) Applicant: AGENCY FOR SCIENCE, TECHNOLOGY AND RESEARCH, Singapore (SG)

(72) Inventors: Liyuan LI, Singapore (SG); Mark David RICE, Singapore (SG); Joo Hwee LIM, Singapore (SG); Suat Ling Jamie NG, Singapore (SG); Teck Sun Marcus WAN, Singapore (SG); Shue Ching CHIA, Singapore (SG); Hong Huei TAY, Singapore (SG); Shiang Long LEE, Singapore (SG)

(21) Appl. No.: 16/090,171

(22) PCT Filed: Mar. 30, 2017
(86) PCT No.: PCT/SG2017/050173

§ 371 Date: Sep. 28, 2018

(30) Foreign Application Priority Data
Mar. 30, 2016 (SG) 10201602513X

(51) Int. Cl. G06K 9/00; G06Q 10/06; G06K 9/62; G06F 3/01; G06T 19/00

(52) U.S. Cl. CPC G06K 9/00671; G06Q 10/06316; G06T 19/006; G06F 3/012; G06K 9/6296

(57) ABSTRACT

According to various embodiments, a method for providing task related information to a user may be provided. The method may include: determining location information based on a spatial model; determining task information based on a task model; determining sensor information; determining output information based on the location information, task information and sensor information; and providing the output information to the user. In a specific embodiment, the output information may comprise an orientation cue, an error indication or a contextual cue to assist the user in performing the task associated with the location detected by a vision recognition method, and the output information can be provided to the user as augmented reality in a wearable device.

### PRIORITY CLAIM

The present application claims priority to Singapore patent application 10201602513X filed on 30 Mar. 2016, which is incorporated herein by reference in its entirety for all purposes.

### TECHNICAL FIELD

The following discloses methods for providing task related information to a user, user assistance systems, and computer-readable media.

### BACKGROUND ART

Various processes in industry are very complex, and it may be difficult for a human operator or a human inspector to assess all aspects that are relevant, for example relevant to operation of a device or machine, relevant to making a decision, and/or relevant to spotting a malfunction.

As such, there may be a desire for support of human operators or human inspectors.

Furthermore, other desirable features and characteristics will become apparent from the subsequent detailed description and the appended claims, taken in conjunction with the accompanying drawings and this background of the disclosure.

### SUMMARY OF INVENTION

According to various embodiments, a method for providing task related information to a user may be provided. The method may include: determining location information based on a spatial model; determining task information based on a task model; determining sensor information; determining output information based on the location information, task information and sensor information; and providing the output information to the user.

According to various embodiments, the spatial model may include at least one of a spatial representation of a position in a work place, a scene recognition model, a vision recognition model for recognizing a body/view orientation, a vision recognition model for estimating a distance to a target position, a vision recognition model for detecting landmarks, and a vision recognition model for recognizing related objects.

According to various embodiments, the task model may include at least one of a position in relation to the spatial model, an indication of a vision task, or an action in relation to a user interface model.

According to various embodiments, the method may further include: determining a state of a task performance; and determining the output information further based on the state.

According to various embodiments, the state may be determined based on a dynamic Bayesian network.

According to various embodiments, determining the sensor information may include or may be included in determining a visual feature of an image.

According to various embodiments, the output information may include at least one of an orientation cue, an error indication, or a contextual cue.

According to various embodiments, the method may be applied to at least one of wire harness assembly, building inspection, or transport inspection.

According to various embodiments, a user assistance system for providing task related information to a user may be provided. The user assistance system may include: a location information determination circuit configured to determine location information based on a spatial model; a task information determination circuit configured to determine task information based on a task model; a sensor configured to determine sensor information; an output information determination circuit configured to determine output information based on the location information, task information and sensor information; and an output circuit configured to provide the output information to the user.

According to various embodiments, the spatial model may include at least one of a spatial representation of a position in a work place, a scene recognition model, a vision recognition model for recognizing a body/view orientation, a vision recognition model for estimating a distance to a target position, a vision recognition model for detecting landmarks, and a vision recognition model for recognizing related objects.

According to various embodiments, the task model may include at least one of a position in relation to the spatial model, an indication of a vision task, or an action in relation to a user interface model.

According to various embodiments, the user assistance system may further include a state determination circuit configured to determine a state of a task performance. According to various embodiments, the output information determination circuit may be configured to determine the output information further based on the state.

According to various embodiments, the state determination circuit may be configured to determine the state based on a dynamic Bayesian network.

According to various embodiments, the sensor may further be configured to determine a visual feature of an image.

According to various embodiments, the output information may include at least one of an orientation cue, an error indication, or a contextual cue.

According to various embodiments, the user assistance system may be configured to be applied to at least one of wire harness assembly, building inspection, or transport inspection.

According to various embodiments, the user assistance system may further include a wearable device including the output circuit.

According to various embodiments, the wearable device may include or may be included in a head mounted device.

According to various embodiments, the output circuit may be configured to provide the output information in an augmented reality.

According to various embodiments, a non-transitory computer-readable medium may be provided. The non-transitory computer-readable medium may include instructions, which when executed by a computer, make the computer perform a method for providing task related information to a user. The method may include: determining location information based on a spatial model; determining task information based on a task model; determining sensor information; determining output information based on the location information, task information and sensor information; and providing the output information to the user.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to illustrate various embodiments, by way of example only, and to explain various principles and advantages in accordance with a present embodiment.

FIG. 1A shows a flow diagram illustrating a method for providing task related information to a user according to various embodiments.

FIG. 1B shows a user assistance system for providing task related information to a user according to various embodiments.

FIG. 1C shows a user assistance system for providing task related information to a user according to various embodiments.

FIG. 2 illustrates an overview of the computational framework according to various embodiments.

FIG. 3 shows an illustration of a further example of an architecture of a general framework according to various embodiments.

FIG. 4 shows an illustration of a spatial cognition model according to various embodiments.

FIG. 5 shows an illustration of a task representation model according to various embodiments.

FIG. 6A and FIG. 6B show illustrations of a graphical model for state tracking according to various embodiments.

FIG. 7 illustrates task phases in relation to interface support according to various embodiments.

FIG. 8 shows an example of a user interface according to various embodiments.

Skilled artisans will appreciate that elements in the figures are illustrated for simplicity and clarity and have not necessarily been depicted to scale. For example, the dimensions of some of the elements in the block diagrams or steps in the flowcharts may be exaggerated in respect to other elements to help improve understanding of the present embodiment.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description. It is the intent of the preferred embodiments to disclose a method and system which is able to assist a user (for example a worker or an engineer) in various tasks (for example visual inspection or operations in industries).

According to various embodiments, a “circuit” may be understood as any kind of a logic implementing entity, which may be special purpose circuitry or a processor executing software stored in a memory, firmware, or any combination thereof. Thus, in an embodiment, a “circuit” may be a hard-wired logic circuit or a programmable logic circuit such as a programmable processor, e.g. a microprocessor (e.g. a Complex Instruction Set Computer (CISC) processor or a Reduced Instruction Set Computer (RISC) processor). A “circuit” may also be a processor executing software, e.g. any kind of computer program, e.g. a computer program using a virtual machine code such as e.g. Java. Any other kind of implementation of the respective functions which will be described in more detail below may also be understood as a “circuit” in accordance with an alternative embodiment.

Various embodiments are described for devices (or systems), and various embodiments are described for methods. It will be understood that properties described for a device may also hold true for a related method, and vice versa.

Various processes in industry are very complex, and it may be difficult for a human operator or a human inspector to assess all aspects that are relevant, for example relevant to operation of a device or machine, relevant to making a decision, and/or relevant to spotting a malfunction.

According to various embodiments, devices and methods may be provided for support of human operators or human inspectors.

According to various embodiments, a wearable assistant, for example for visual inspection and operation in industries, may be provided.

Visual inspection and operation assistance may be a device or method (in other words: process) that assists human memory in making judgments, and performing specified operations on a set of procedural tasks.

According to various embodiments, a computational framework and system architecture of a wearable mobile assistant may be provided, for example for visual inspection and operation in industrial-related tasks.

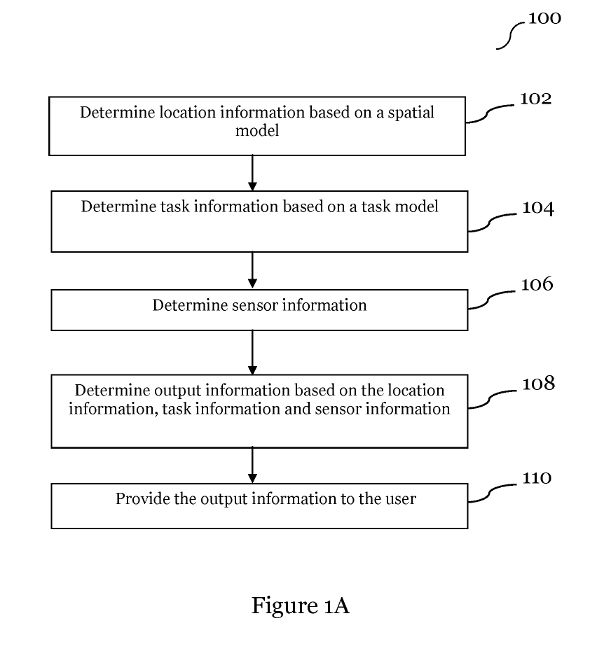

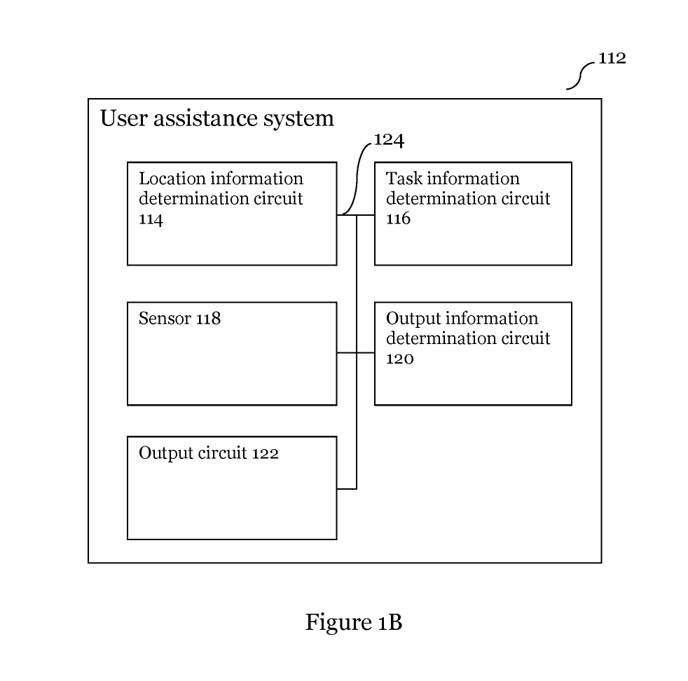

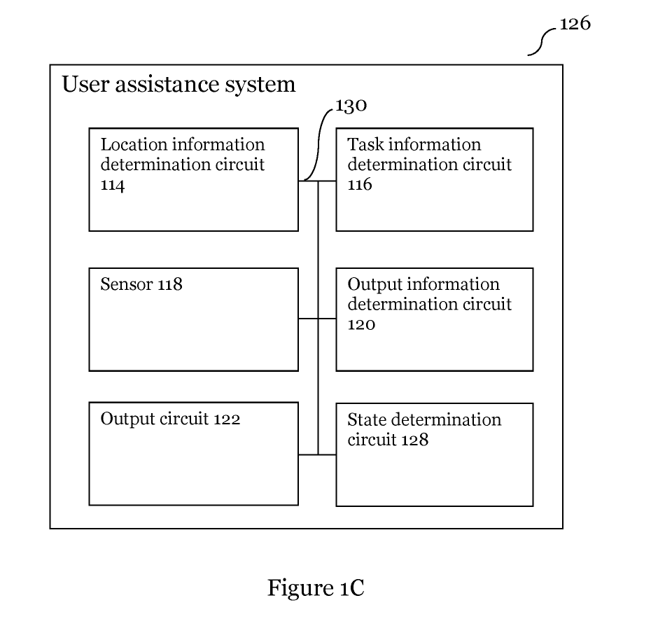

FIG. 1A shows a flow diagram 100 illustrating a method for providing task related information to a user according to various embodiments. In 102, location information may be determined based on a spatial model. In 104, task information may be determined based on a task model. In 106, sensor information may be determined. In 108, output information may be determined based on the location information, task information and sensor information. In 110, the output information may be provided to the user. Location information may include or may be information related to an environment in which the user is to perform a task, and may include information on the locations of the user, a work piece, a tool, or information that may be used for determining where the user is (for example signs). A task may for example include subtasks, or waypoints where the user is desired to get to perform the task. Output information may be any kind of information that is to be provided to the user for assisting him in performing the task.

In other words, location information and task information may be used to determine and present to a user information that supports the user in performing a task.

According to various embodiments, the spatial model may include at least one of a spatial representation of a position in a work place, a scene recognition model, a vision recognition model for recognizing a body orientation, a vision recognition model for estimating a distance to a target position, a vision recognition model for detecting landmarks, and a vision recognition model for recognizing related objects.

According to various embodiments, the task model may include at least one of a position in relation to the spatial model, an indication of a vision task, or an action in relation to a user interface model.

According to various embodiments, the method may further include: determining a state of a task performance; and determining the output information further based on the state.

According to various embodiments, the state may be determined based on a dynamic Bayesian network.

According to various embodiments, determining the sensor information may include or may be included in determining a visual feature of an image.

According to various embodiments, the output information may include at least one of an orientation cue, an error indication, or a contextual cue.

According to various embodiments, the method may be applied to at least one of wire harness assembly, building inspection, or transport inspection.

FIG. 1B shows a user assistance system 112 for providing task related information to a user according to various embodiments. The user assistance system 112 may include a location information determination circuit 114 configured to determine location information based on a spatial model. The user assistance system 112 may further include a task information determination circuit 116 configured to determine task information based on a task model. The user assistance system 112 may further include a sensor 118 configured to determine sensor information. The user assistance system 112 may further include an output information determination circuit 120 configured to determine output information based on the location information, task information and sensor information. The user assistance system 112 may further include an output circuit 122 configured to provide the output information to the user. The location information determination circuit 114, task information determination circuit 116, the sensor 118, the output information determination circuit 120, and the output circuit 122 may be coupled, for example mechanically coupled or electrically connected, like illustrated by lines 124.

According to various embodiments, the spatial model may include at least one of a spatial representation of a position in a work place, a scene recognition model, a vision recognition model for recognizing a body/view orientation, a vision recognition model for estimating a distance to a target position, a vision recognition model for detecting landmarks, and a vision recognition model for recognizing related objects.

According to various embodiments, the task model may include at least one of a position in relation to the spatial model, an indication of a vision task, or an action in relation to a user interface model.

FIG. 1C shows a user assistance system 126 for providing task related information to a user according to various embodiments. The user assistance system 126 may, similar to the user assistance system 112 shown in FIG. 1B, include a location information determination circuit 114 configured to determine location information based on a spatial model. The user assistance system 126 may, similar to the user assistance system 112 shown in FIG. 1B, further include a task information determination circuit 116 configured to determine task information based on a task model. The user assistance system 126 may, similar to the user assistance system 112 shown in FIG. 1B, further include a sensor 118 configured to determine sensor information. The user assistance system 126 may, similar to the user assistance system 112 shown in FIG. 1B, further include an output information determination circuit 120 configured to determine output information based on the location information, task information and sensor information. The user assistance system 126 may, similar to the user assistance system 112 shown in FIG. 1B, further include an output circuit 122 configured to provide the output information to the user. The user assistance system 126 may further include a state determination circuit 128, like will be described in more detail below. The location information determination circuit 114, task information determination circuit 116, the sensor 118, the output information determination circuit 120, the output circuit 122, and the state determination circuit 128 may be coupled, for example mechanically coupled or electrically connected, like illustrated by lines 130.

According to various embodiments, the state determination circuit 128 may be configured to determine a state of a task performance. According to various embodiments, the output information determination circuit 120 may be configured to determine the output information further based on the state.

According to various embodiments, the state determination circuit 128 may be configured to determine the state based on a dynamic Bayesian network.

According to various embodiments, the sensor 118 may further be configured to determine a visual feature of an image.

According to various embodiments, the output information may include at least one of an orientation cue, an error indication, or a contextual cue.

According to various embodiments, the user assistance system 126 may be configured to be applied to at least one of wire harness assembly, building inspection, or transport inspection.

According to various embodiments, the user assistance 126 system may further include a wearable device (not shown in FIG. 1C) including the output circuit 122.

According to various embodiments, the wearable device may include or may be or may be included in a head mounted device.

According to various embodiments, the output circuit 122 may be configured to provide the output information in an augmented reality.

According to various embodiments, a non-transitory computer-readable medium may be provided. The non-transitory computer-readable medium may include instructions which, when executed by a computer, make the computer perform a method for providing task related information to a user (for example the method described above with reference to FIG. 1A).

A professional task in industrial visual inspection may be a knowledge-intensive activity, requiring domain knowledge and cognitive perception. Cognitive psychology identifies three categories of knowledge for intelligence: declarative knowledge, procedural knowledge and reactive knowledge.

According to various embodiments, a computational framework may be provided for a wearable mobile assistance for visual inspection in industrial applications. According to various embodiments, domain knowledge (as an example of declarative knowledge of workspace and tasks), task monitoring based on cognitive visual perception (as an example of procedural knowledge of the task), and a user interface (as an example of reactive knowledge) may be integrated based on augmented reality for real-time assistance.

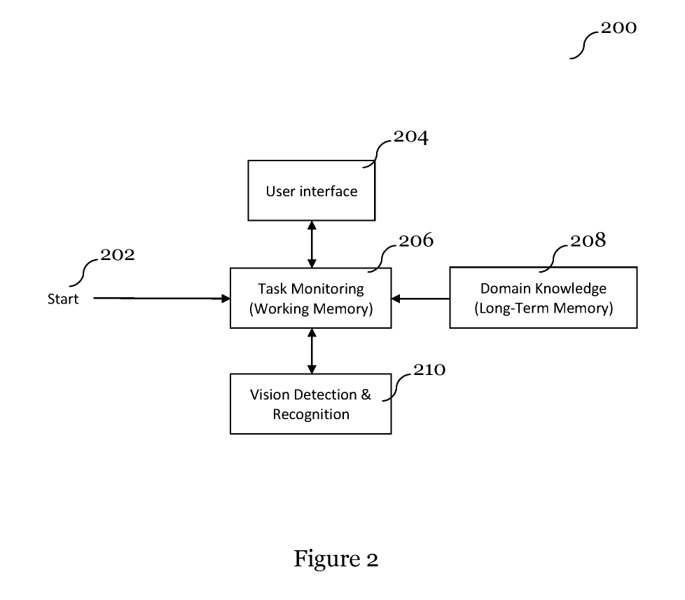

FIG. 2 shows an illustration 200 of an architecture of a computational framework according to various embodiments. Domain knowledge 208 may represent the declarative knowledge of the tasks stored in long-term memory. This may include spatial knowledge of the workspace and task knowledge. Vision detection and recognition 210 may represent a set of vision algorithms for real-time perception from a first-person perspective. For a given task (for example once the task has been started, like indicated by 202), a working memory 206 may be instantiated according to the domain knowledge, and the working memory 206 may perform online reasoning based on real-time visual perception to track and monitor the task procedure. When required, instructions may be provided to the user through an easy-to-use interface 204.

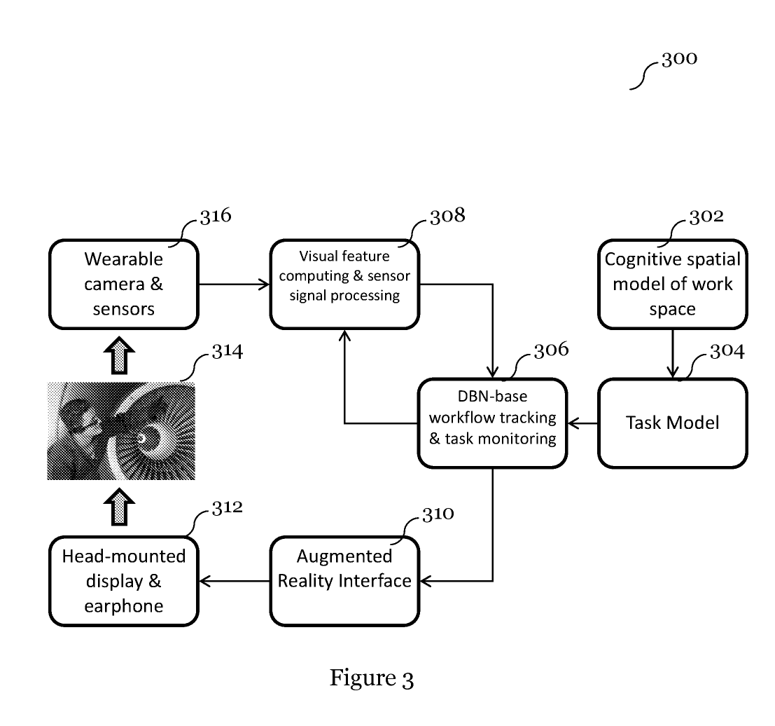

FIG. 3 shows an illustration 300 of a further example of an architecture of a general framework according to various embodiments, for example an augmented intelligence platform (AIP), for example for intelligent visual interactions. A representation of spatial knowledge of a workspace (for example as illustrated by a cognitive spatial model of work space 302) may provide data to task knowledge (for example as illustrated by a task model 304), which may provide input to a Dynamic Bayesian Network (DBN)-based workflow tracking and task monitoring module 306. The DBN-based workflow tracking and task monitoring module 306 may provide data to a visual feature computing and sensor signal processing module 308 and an augmented reality interface 310 with wearables as an example of the user interface. For example, the augmented reality module 310 may provide data to a head-mounted display and earphones 312, for example like shown in illustration 314, and a wearable camera and sensors 316 (which may be mounted on the head-mounted display and earphones 312 or which may be provided separate from the head-mounted display and earphones 312) may provide data to the visual feature computing and sensor signal processing module 308.

According to various embodiments, the wearable assistant system may perform online tracking of a task, and may provide help on aspects of ‘where’, ‘what’, ‘how’, ‘when’, and ‘why’, which corresponds to:
Where the user is in the workspace, including their head orientation;
What the user is looking at, and what they should pay attention too;
How to perform a required operation;
When to move attention; and/or
Why they have to perform a certain operation.

In the following, a long-term memory for domain knowledge representation will be described. According to various embodiments, the long-term memory of domain knowledge may be incorporated by two models: the model of spatial knowledge (or model of spatial cognition) and the model of task representation.

In the following, the model of spatial cognition according to various embodiments will be described.

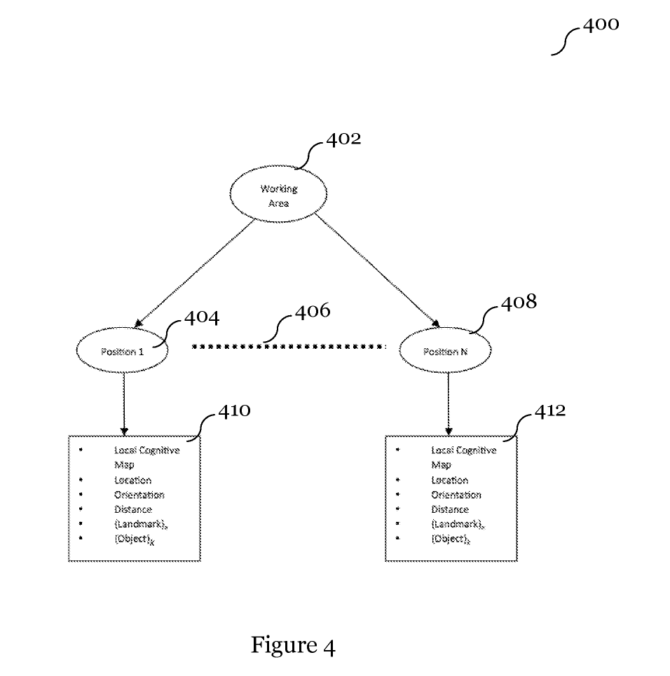

Each task of visual inspection in an industrial application may be performed in a restricted working area. The workspace may further be divided into several positions. At each position, one or more specified operations are to be performed on related objects. According to various embodiments, a hierarchical structure model may be provided to represent the spatial knowledge for a specific task of visual inspection and operation, as shown in FIG. 4.

FIG. 4 shows an illustration 400 of a model of spatial recognition according to various embodiments. A root node 402 may denote the working area of the task. It may include semantic and declarative descriptions of the workspace, and the spatial relationship of the child nodes 404, 406, 408. The child nodes 404, 406, 408 may represent the specific positions where each individual activity has to be performed. Each position my include a local cognitive map, a location, an orientation, a distance, one or more landmarks, and/or one or more objects, like illustrated by box 410 for the first position 404, and by box 412 for the n-th position 412.

According to various embodiments, a frame structure may be employed to integrate both declarative knowledge of spatial information, and vision models to perform visual spatial perception. In each node, the local cognitive map may describe the allocentric location in the workspace and geometrical relations of view-points, landmarks, and other related objects. The node may also include vision recognition models (e.g. SVM (Support Vector Machine) models or image templates) for location recognition (for example scene recognition), orientation recognition, distance estimation, and detection of landmarks in the surrounding region.

Combining this spatial knowledge of an allocentric cognitive map and egocentric vision descriptions of the corresponding working position, the system according to various embodiments may be able to know where the user is, what the user is looking at, what the user should do next, and other similar information. The model of spatial cognition may cover all the positions in the working area for the tasks of visual inspection.

For example, as described above and as illustrated by the boxes 410, 412 in FIG. 4, the information in each leaf node may be as follows:
Local cognitive map: allocentric spatial representation of the position in the work place;
Location: GPS (Global Positioning System) data and scene recognition model;
Orientation: vision recognition model to recognize body orientation from PFV (first-person-view) observation;
Distance: vision recognition model to estimate the distance to the target position;
Landmark: vision recognition model to detect landmarks around the position in the FPV image; and/or
Object: vision recognition model to recognize related objects in a user's field of view.

In the following, a model of task representation according to various embodiments will be described.

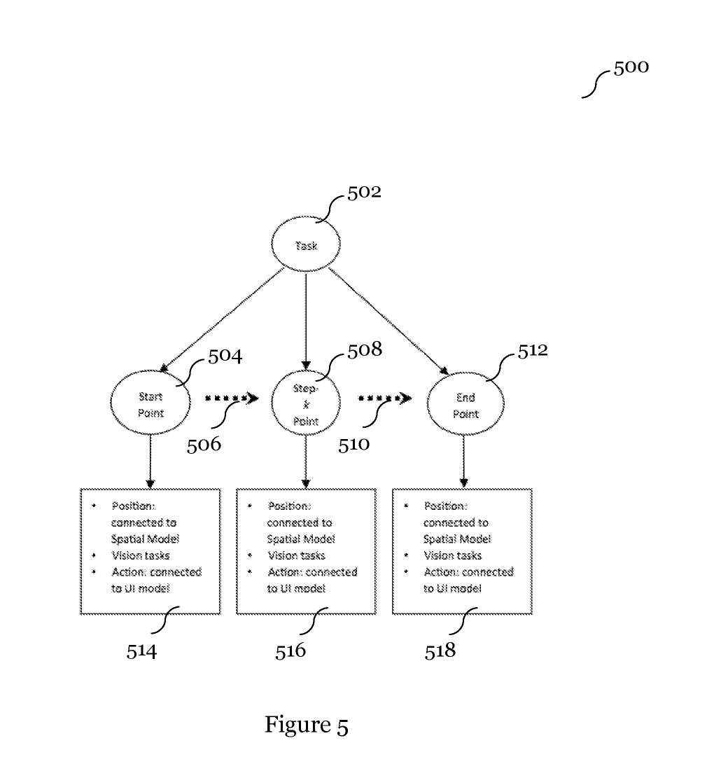

The procedural knowledge may describe each task as a series of steps to solving a problem. The graphical model is employed to describe the procedural knowledge of a given task, as shown in FIG. 5.

FIG. 5 shows an illustration 500 of a model of task representation according to various embodiments. Each task 502 may be represented as a sequence of steps (i.e. subtasks) performed at specified positions 504, 506, 508, 510, 512. At each node of a step, a frame structure may be employed (like illustrated by box 514 for start point 504, box 516 for step-k point 508, and box 518 for end point 512) to store the information on spatial cognition, vision tasks and actions of assistance for the subtask.

In the frame structure, a position slot may store a pointer to a position node in the model of spatial knowledge (in other words: a position connected to the spatial model). A slot of vision tasks may describe what vision operations are to be performed based on the information from the position node in spatial knowledge model, such as scene recognition, orientation and distance estimation, viewpoint to the working surface, landmark or object detection. An action slot may store a pointer connecting to the user interface (UI) model to describe what kind of assistance should be provided at a given instance, based on visual perception.

In the following, working memory for task tracking and monitoring according to various embodiments will be described.

According to various embodiments, once a task is selected, a dynamic model of the procedure may be generated by extracting related knowledge and information from the spatial and task models in long-term memory. According to various embodiments, a graphical model to represent the task in working memory and a dynamic Bayesian network (DBN) model for state tracking may be provided.

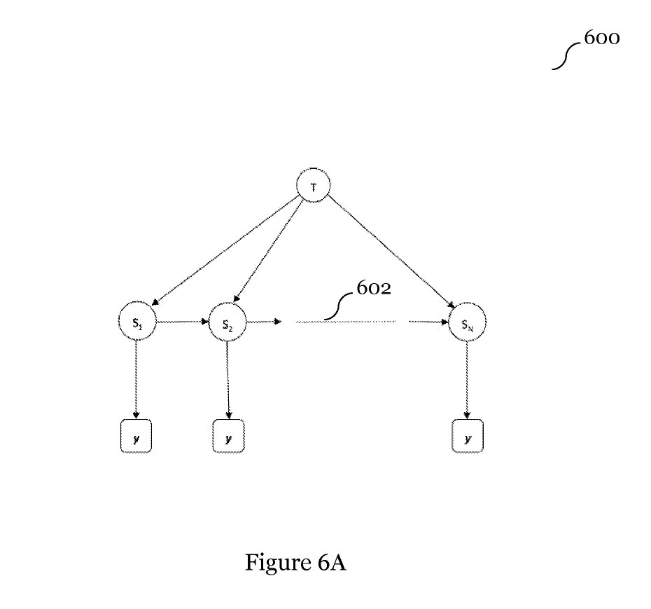

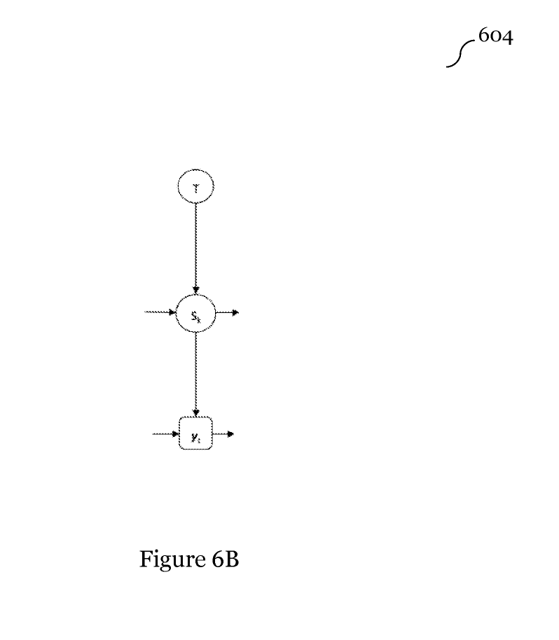

FIG. 6B shows an illustration 600 of a graphical model of a task, where the root node T indicates the task, its child nodes Sₖ (a first node S₁, a second node S₂, further nodes illustrated by dotted line 602, and an N-th node S_{N}) represent the sequence of states (for example steps or subtasks), and the nodes y denote the vision observations, or the results of vision detection and recognition of a state. The probabilities of state transitions may depend on descriptions of the operation of steps and visual observations.

According to various embodiments, a DBN model may be provided to describe the dynamic procedure of a specific task. One particular state may be described as a t-slice DBN as shown in illustration 604 of FIG. 6B. The whole dynamic procedure may be represented by an unrolled DBN for T consecutive slices.

Assuming that the task takes T time steps (wherein it will be clear from the context whether T refers to a time or to a node of a task, like in FIGS. 6A and 6B), the sequence of observable variables may be denoted as Y_{T}={y₀, . . . , y_{T-1}}. At a time step t, the user may be performing subtask sₖ. According to the fundamental formulation of DBN, the joint distribution can be expressed as

$$P ( {Y}_{T} , {S}_{K} ) = p ( {s}_{0} ) {\prod }_{t = 1}^{T - 1} p ( {s}_{k}^{t} \vert {s}_{k - 1}^{t} ) {\prod }_{t = 1}^{T - 1} p ( {y}_{t} \vert {s}_{k}^{t} ) \qquad ( 1 )$$

The prior and state transition pdfs (probability density functions) are defined on the task knowledge representation. The probability p(sₖ|sₖ₋₁) is high if the operation for subtask sₖ₋₁ has been completed in the previous time steps, otherwise, it is low. The observation probability p(yₜ|sₖ) may be defined on the models of task and spatial knowledge. If the scene and objects related to subtask sₖ are observed, the probability p(yₜ|sₖ) is high, otherwise, it is low. If the sequence of visual observations match the description of the task (e.g., scene matches the position, viewpoint matches working surface, and activity matches operation), the joint probability P(Y_{T},S_{K}) is high, otherwise, it is low.

According to various embodiments, the joint probability (1) may be exploited to perform online state inference for state tracking. At any time t during the task, it may be desired to estimate the user's state sₜ according to the observations made so far. According to (1), this may be expressed as:

$${\hat{s}}_{t} = arg {max}_{k} P ( {Y}_{t} , {S}_{K} ) \qquad ( 2 )$$

From (1), the log pdf may be obtained as

$$\begin{matrix}{Q}_{t} = log P ( {Y}_{t} , {S}_{K} ) = {\sum }_{i = 1}^{t} log p ( {s}_{k}^{i} \vert {s}_{k - 1}^{i} ) + {\sum }_{i = 1}^{t} log p ( {y}_{t} \vert {s}_{k}^{i} ) + log p ( {s}_{0} ) \\ = {\sum }_{i = 1}^{t - 1} log p ( {s}_{k}^{i} \vert {s}_{k - 1}^{i} ) + {\sum }_{i = 1}^{t - 1} log p ( {y}_{t} \vert {s}_{k}^{i} ) + log p ( {s}_{0} ) + \\ log p ( {s}_{k}^{t} \vert {s}_{k - 1}^{t} ) + log p ( {y}_{t} \vert {s}_{k}^{t} ) \\ = {Q}_{t - 1} + {q}_{t}\end{matrix}$$

Hence, the current state can be obtained as

$${\hat{s}}_{t} = arg {max}_{k} {q}_{t} ∝ arg {max}_{k} [ p ( {s}_{k}^{t} \vert {s}_{k - 1}^{t} ) p ( {y}_{t} \vert {s}_{k}^{t} ) ]$$

In the following, vision functions according to various embodiments will be described. Various vision functions, such as image classification for scene recognition, image recognition and retrieval for working place recognition, viewpoint estimation for spatial perception in working point, object detection, sign detection and text recognition, hand segmentation and gesture recognition for action recognition, may be provided in the framework according to various embodiments to perform working state monitoring.

According to various embodiments, various computer vision techniques may be employed and customized for tasks in different industrial applications. According to various embodiments, various vision functions may be provided which may be deployed for general scenarios, while customized for special situations.

In the following, scene recognition according to various embodiments will be described. To help a user in a task, it may be important to know where the user is. According to various embodiments, a vision-based scene recognition for workplace and position recognition may be provided. According to the domain knowledge representation, the system may perform scene recognition in hierarchical levels. First, at a top level, the scene recognition algorithm may classify the observed scenes into two categories: workspace or non-workspace. If the user is within the workspace area, a multi-class scene recognition may be performed to estimate the user's position, so that the system can predict what subtask the user has to perform.

According to various embodiments, a scene recognition model for workspace and position recognition may be provided. For a general case, SVM models may be trained only on gradient features. While special scenes may be considered, it may be extended to involve color features on semantic color names. According to various embodiments, for example when applied to wire routing, at the top level, the scene recognition model may be trained to recognize if the user has entered the working area and is facing the correct orientation to the assembly board.

In the following, distance and orientation estimation according to various embodiments will be described. Once the user enters a workspace, the user's visual attention may be interesting, for example, if the user is at the correct task region, or how far the user is to the target position, so as to estimate what action should be taken, and what helping information should be provided.

Taking wire harness assembly as an example, once the user enters the workspace, the devices or methods according to various embodiments may keep estimating the user's distance and orientation (i.e. working position), so it can understand the user's current state, predict the user's next action, and the required guidance in the task. Instead of precise detection keypoints for 3D reconstruction of the scene and viewpoint, which depends on 3D sensors, a vision method based on cognitive spatial perception of a user's workspace position may be provided according to various embodiments.

According to various embodiments, in cognitive concepts of spatial relations to a working place and operation point, when a user is standing facing a working board, the visual attention may be semantically described as “direct” to board, or looking at “up”, “down”, “left” or “right” side, and the distance may be represented as “close”, “near”, “moderate”, “far” and “far away”. The definitions of such cognitive concepts may be fuzzy but they may be informative enough for a user to understand his/her situation and make decision on the next action.

According to various embodiments, a learning method may be provided to learn such spatial concepts during working just from FPV (first person view) images. The tilt angles of viewpoints may be roughly classified into 3 categories, i.e., ‘−1’ for “up”, ‘0’ for “direct”, and ‘+1’ for “down”, and the pan angles of viewpoints may be roughly classified into 5 categories as ‘−2’ for “far-left”, ‘−1’ for “left”, ‘0’ for “direct”, ‘+1’ for “right” and ‘+2’ for “far-right”, respectively.

According to various embodiments, the distance to the board may be quantified into 5 categories, for example 1′ for “close”, ‘2’ for “near”, ‘3’ for “moderate”, ‘4’ for “far”, and ‘5’ for “far away”. According to various embodiments, a mapping from an input image to a set of scores representing cognitive spatial concepts on pan and tilt angles, as well as distance to the working location may be learned.

For an image from a working position, first a PHOG (Pyramid Histograms of Gradients) as a global representation of the image may be computed. The obtained image descriptor f may be a high-dimensional feature vector. PCA (Principal Component Analysis) may be used to transform f as a low-dimensional feature vector x=[x₁, . . . , x_{K}], where K may be selected as about 20 to 40. A hybrid linear model may be provided to learn the mapping from the feature space x∈R^{K} to the score of a cognitive spatial concept. The hybrid linear model may learn a general mapping for all samples, and customized fine-tuning for some difficult samples. Let y represent the corresponding score of a cognitive spatial concept, e.g. the tilt angle of a viewpoint. Then the hybrid linear model may be expressed as

$$y = [ {\sum }_{j = 1}^{K} {a}_{j} {x}_{j} + {a}_{0} ] + [ {\sum }_{p} {w}_{p} {a}_{p} ] , with the weight {w}_{p} = exp ( - \frac{{‖ {x}_{p} - x ‖}^{2}}{2 {σ}^{2}} )$$

where the first part (in other words: first summand) may be a general linear regression model trained for all samples, and the second part (in other words: second summand) may be an additional fine-tuning bias customized on a neighbourhood sample in a complex training set. The hybrid model may be trained in two steps. In a first step, the general model may be trained on all the training samples. Then, in a second step, the top 20% of the most complex samples may be selected, from (or to) which the general model may be applied.

In the following, landmark recognition according to various embodiments will be described. In industrial inspection, there may often be a few specific and distinctive places and objects related to a task. These scenes and objects may be recognized by employing image matching techniques. According to various embodiments, a few images of the landmark may be stored in the spatial model. When approaching the working position, the input images may be compared with the stored images for landmark recognition.

According to various embodiments, a standard CBIR (Content Based Image Retrieval) pipeline with SIFT (Scale-invariant feature transform) features may be used. A short list of candidates may be found with an inverted file system (IFS), followed by geometric consistency checks with RANSAC (Random sample consensus) on top matches. If no landmark image passes RANSAC, the top match from the IFS may be declared to be a match landmark image.

In the following, object detection according to various embodiments will be described. In a workspace position, there may be one or two (or more) specific objects related to a specified task of examination or operation. According to various embodiments, HOG (histogram of oriented gradients) and SVM detector may be provided for object detection. The devices and methods according to various embodiments may perform active object detection under the guidance of position, distance and viewpoint estimation in the workspace. Thus, advantageously, the devices and methods according to various embodiments may achieve fast and robust object detection.

In the following, sign detection and text recognition according to various embodiments will be described. In the work place, there may be signs and marks to guide the user for correct operations. Signs and marks may be specially designed for people to easy find and understand, and they may be detected by devices and methods according to various embodiments.

In the following, hand detection and gesture recognition according to various embodiments will be described. According to various embodiments, devices and methods for hand segmentation in FPV videos may be provided. First, fast super-pixel segmentation may be performed. Then, a trained SVM may classify each super-pixel as skin region or not, for example based on colour and texture distributions of the super-pixel. The connected super-pixels of skin colour may be segmented into regions of hands based on the spatial constraints from FPV.

According to various embodiments, HMM (hidden Markov model) or DBN may be trained for hand gesture recognition.

In the following, a user interface according to various embodiments will be described.

According to various embodiments, an augmented reality interface may advantageously provide the ability to front-project information that might otherwise be hidden, concealed or occluded from a user's field of view.

According to various embodiments, in the display, information may be color-coded to match that of the task, and to enable information to be clearly distinguished from other on-screen (graphic) objects. Graphical information may be scaled to accommodate for different screen sizes—e.g. a wearable display compared to a portable tablet. According to various embodiments, the user interface may be designed to:
Sequentially order task information to reflect the operation at hand;
Provide real-time visual recognition and augmented prompts for task errors;
Provide contextual navigational information on the proximity and orientation of an object being inspected; and/or

Intelligently adapt the display of information depending on the user's viewing angle and distance.

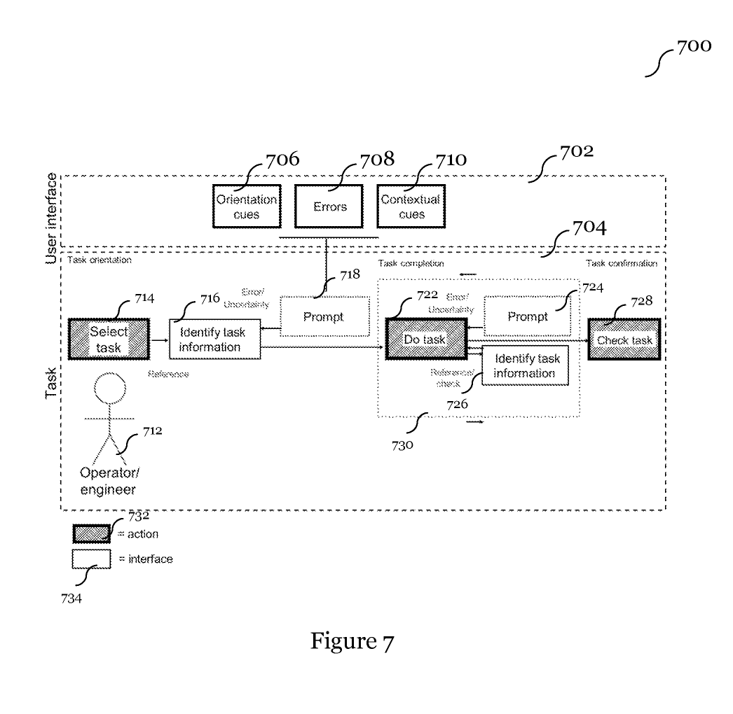

FIG. 7 shows an illustration 700 of task phases in relation to interface support. A user interface may be provided, like indicated by box 702. Task related actions (like indicated by dark grey boxes, like example dark grey box 732) and task related interface (like indicated by white boxes, like example white box 734) may be provided, like indicated by box 704. In terms of task completion, the user interface may support three phases of operation: select task 714, do task 730, and check (or verify) task 728. In 716, task information may be identified. In 726, task information may be identified. In 718, a user may be prompted for input. In 724, a user may be prompted for input.

For task orientation 714, information may initially be displayed in the user interface to help guide the user orientate into position, for example by identifying start and end points, location of the assembly objects, and/or the location to move towards.

For task completion 730, ‘on doing’ the actual task, like illustrated by shaded box 722, information may flag up in the display when physical errors are identified. Furthermore, contextual information may be updated based on the users changing movement and orientation in the inspection procedure.

For task confirmation 728, on completing the task, the user may need to check the inspection task is correct. Here, the interface may highlight the completed sequence of a task or sub-task to enable the user to make comparisons to the real-world.

The user for example may be an operator 712 (or for example an engineer).

According to various embodiments, to support these three phases of operation, intelligent features in the user interface may include the ability to automatically scale graphical detail dependent on the user's proximity to the task, provide navigational cues to direct orientation, and support real-time error correction. These features may be based on the implementation of the visual functions and framework previously described.

Orientation cues 706 may be provided in the user interface 702. Graphical and audio cues may be provided to visually demonstrate the physical direction to the task. Information on the display may update directions and distance to a target object in real-time. This may be useful when orientating over a large distance. Features of the orientation cues 706 may include:
Highlighting relevant textual signs, labels, and keypoints in a user's field of view;
Providing directional cues to target objects; and/or
Indicating distance to the target objects, orientation of gaze.

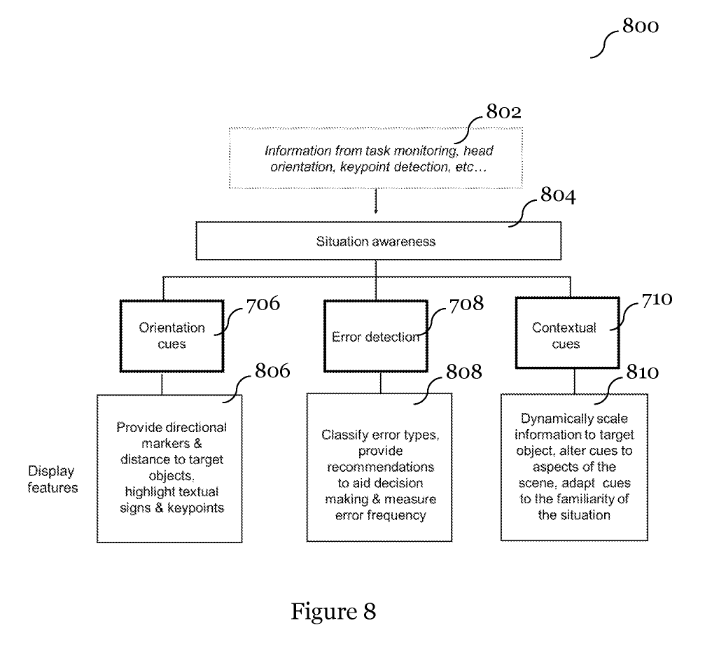

Information related to errors 708 may be provided in the user interface 702, for example related to error detection and recovery. Errors may include real-time errors detected in the inspection task, such as sequencing information in the wrong order, or the wrong placement of a target object. The system may highlight the error in the display, as well as provide suggestions for corrected actions (like illustrated in FIG. 8). Information may be graphically displayed with the aid of audio prompts. Features of providing the error information may include:
Classifying error type (slip, violation, wrong state, etc.);
Displaying error message using natural and informative dialog;
Providing recommendations to support decision making and guidance; and/or
Measuring error frequency to determine the type of feedback used.

Contextual cues 710 may be provided in the user interface 702. To reduce visual clutter and improve attention and visual search, the display of graphical information may automatically adapt and scale to the position of the user. This may advantageously reduce distractions in the environment, as information is prioritised in the task to support visual guidance. Features of the contextual clues 710 may include:
Scaling information based on the users distance to a task object;
Altering contextual cues based on relevant aspects of a scene; and/or
Adapting contextual cues based on the user's familiarity of the situation.

FIG. 8 shows an illustration 800 of a user interface, for example a dynamic user interface. In 802, information from task monitoring, head orientation, keypoint detection or any other suitable information may be determined. In 804, a situation awareness method may determine which of the orientation cues 706, error detection 708, and/or contextual cues 710 the user interface is to provide. The orientation cues 706 may, like indicated by box 706, provide directional markers and distance to target objects, and/or highlight textual signs and/or keypoints. The error detection 708 may, like indicated by box 808, classify an error type, provide recommendations to aid decision making, and/or measure error frequency. The contextual clues 710 may, like indicated by box 810, dynamically scale information to a target object, alter cues to aspects of the scene, and/or adapt cues to the familiarity of the situation.

Various embodiments may be provided for wire harness assembly. The wire harness assembly industry may for example be related to aerospace, automobile, and shipping. During the wire harness process, operators are often required to sequentially assemble wires and wire bundles together on a specialized board, or work bench. Wire routing may involve a large workforce, and be very labor-intensive, resulting in high manufacturing costs. To support this process, devices and methods according to various embodiments may:
Guide the user to the correct assembly board through navigational instructions and cues. This includes guiding head orientation to focus on regions of interest.
Visualize the start and end points for the wire sequences through the detection of keypoints and other board features.
Display the route sequence, including the direction to assemble the route through appropriate navigational cues.
Detect and highlight errors in real-time that relate to the wrong position, or placement of wires, including their correction.
Provide adjustment for the graphical features based on the user's position to the assembly board. For example, at a close distance to an intersection, or complex area of wires, details on the wire layer sequence may be displayed, while stepping back can simplify the information so that the user can focus on more relevant information in the task.

Various embodiments may be applied to building inspection. Building inspection may cover a wide spectrum of activities from surveying exterior and interior structures, repair work, to providing reports on poor installation and ceiling, windows and floors defects. Devices and methods according to various embodiments may:
Augment an underlying structure behind a wall or other occluded object.
Provide navigational cues to orientate a user to the assembly or structural point in the building. This includes orientation to guide the user's direction to turn.
Once at the appropriate structure, sequentially highlight the assembly or inspection task. This includes illustrating which features to modify or interact with. This information is sequentially ordered to reduce memory demands. For example, as the user moves across the structure, information may be displayed relevant to the task or sub-task. Completed sections may automatically fade out of view.

According to various embodiments, in the event that an object is incorrectly positioned, a warning message may automatically flag up in the user's field of view. Prompt messages may then be provided to correct the sub-task, such as the position to orientate the object.

On completing the inspection task, the user may request the full structure be augmented to trace back through the order sequence.

Various embodiments may be applied to transport inspection. Inspection of transport may include trains, ships, airplanes, or other commercial vehicles. This may involve either the internal or external inspection of the vehicle. This may for example, be part of a surface structure of a ship, or internal cabin of an aircraft. Various embodiments may augment both visible and concealed information during the inspection process.

When inspecting over a wide surface area, the sequence of information around the structural surface may be augmented. According to various embodiments, it may be differentiated between faults and incorrect states. According to various embodiments, key features for inspection and scale information may be highlighted based on the user's proximity. According to various embodiments, it may easily be switched between the inspection of different object sizes—macro and micro views—e.g. the nose of an airplane, versus a small fault. According to various embodiments, it may be highlighted and distinguished between surface objects to inspect (e.g. vents, flaps, etc.), and deviations in their structure (e.g. stress, deformation, deterioration, etc.).

The devices and methods according to various embodiments (for example according to the computational framework according to various embodiments) may assist the user in the visual guidance of inspection and operation tasks that require following a complex set of navigational steps or procedures. In this context, a ‘user’ can be a factory operator, technician, engineer or other workplace personnel.

Various embodiments provide real-time navigational guidance using an augmented visual display. This may allow hands free interaction, and an intelligent approach to displaying information in a user's field of view (i.e. FPV, First-Person-View).

According to various embodiments, a framework and algorithms may be provided, which can actively detect features in the workplace environment using cognitive domain knowledge and real-time video stream from an optical wearable camera, and sequence information in a dynamic interface to help reduce the working memory, while adding the skill demands of the user.

Various embodiments may provide real-time visual recognition of scene and objects, task errors and surface anomalies, may logically sequence task information to support memory and visual guidance, may provide contextual information to aid in orientation of the inspected area, may adapt the display of visual information to suit the task and environment, and/or may provide an easy to learn user interface.

Various embodiments advantageously may provide reference to information concealed or occluded from view, may help reduce human errors and uncertainty, may improve task efficacy through appropriate strategies and decision making, may reduce the need for paper documentation, and/or may avoid the need for AR markers.

Various embodiments may be used for various tasks, for example assembly, maintenance, emission monitoring, shift operation, incident reporting, control room monitoring, security patrol, equipment, and/or waste management.

Various embodiments may be used in various industries, for example manufacture, power generation, construction, oil and gas, hydro and water, petrochemical, mining, environment, and/or science and research.

While exemplary embodiments have been presented in the foregoing detailed description of the invention, it should be appreciated that a vast number of variations exist.

It should further be appreciated that the exemplary embodiments are only examples, and are not intended to limit the scope, applicability, operation, or configuration of the invention in any way. Rather, the foregoing detailed description will provide those skilled in the art with a convenient road map for implementing an exemplary embodiment of the invention, it being understood that various changes may be made in the function and arrangement of elements and method of operation described in an exemplary embodiment without departing from the scope of the invention as set forth in the appended claims.

1. A method for providing task related information to a user, the method comprising:
determining location information based on a spatial model;
determining task information based on a task model;
determining sensor information;
determining output information based on the location information, task information and sensor information; and
providing the output information to the user.

2. The method of claim 1,
wherein the spatial model comprises at least one of a spatial representation of a position in a work place, a scene recognition model, a vision recognition model for recognizing a body orientation, a vision recognition model for estimating a distance to a target position, a vision recognition model for detecting landmarks, and a vision recognition model for recognizing related objects.

3. The method of claim 1,
wherein the task model comprises at least one of a position in relation to the spatial model, an indication of a vision task, or an action in relation to a user interface model.

4. The method of claim 1, further comprising:
determining a state of a task performance; and
determining the output information further based on the state.

5. The method of claim 4,
wherein the state is determined based on a dynamic Bayesian network.

6. The method of claim 1,
wherein determining the sensor information comprises determining a visual feature of an image.

7. The method of claim 1,
wherein the output information comprises at least one of an orientation cue, an error indication, or a contextual cue.

8. The method of claim 1,
wherein the method is applied to at least one of wire harness assembly, building inspection, or transport inspection.

9. A user assistance system for providing task related information to a user, the user assistance system comprising:
a location information determination circuit configured to determine location information based on a spatial model;
a task information determination circuit configured to determine task information based on a task model;
a sensor configured to determine sensor information;
an output information determination circuit configured to determine output information based on the location information, task information and sensor information; and
an output circuit configured to provide the output information to the user.

10. The user assistance system of claim 9,
wherein the spatial model comprises at least one of a spatial representation of a position in a work place, a scene recognition model, a vision recognition model for recognizing a body orientation, a vision recognition model for estimating a distance to a target position, a vision recognition model for detecting landmarks, and a vision recognition model for recognizing related objects.

11. The user assistance system of claim 9,
wherein the task model comprises at least one of a position in relation to the spatial model, an indication of a vision task, or an action in relation to a user interface model.

12. The user assistance system of claim 9, further comprising:
a state determination circuit configured to determine a state of a task performance; and
wherein the output information determination circuit is configured to determine the output information further based on the state.

13. The user assistance system of claim 12,
wherein the state determination circuit is configured to determine the state based on a dynamic Bayesian network.

14. The user assistance system of claim 9,
wherein sensor is further configured to determine a visual feature of an image.

15. The user assistance system of claim 9,
wherein the output information comprises at least one of an orientation cue, an error indication, or a contextual cue.

16. The user assistance system of claim 9,
wherein the user assistance system is configured to be applied to at least one of wire harness assembly, building inspection, or transport inspection.

17. The user assistance system of claim 9, further comprising:
a wearable device comprising the output circuit.

18. The user assistance system of claim 17,
wherein the wearable device comprises a head mounted device.

19. The user assistance system of claim 9,
wherein the output circuit is configured to provide the output information in an augmented reality.

20. A non-transitory computer-readable medium comprising instructions which, when executed by a computer, make the computer perform a method for providing task related information to a user, the method comprising:
determining location information based on a spatial model;
determining task information based on a task model;
determining sensor information;
determining output information based on the location information, task information and sensor information; and
providing the output information to the user.
